(19) United States
(12) Patent Application Publication
(10) Pub. No.: US 2005/0221100 A1
(43) Pub. Date: Oct. 6, 2005

(54) Three dimensional periodic structure and method of producing the same

(75) Inventors: Soshu Kirihara, Osaka-fu (JP); Yoshinari Miyamoto, Osaka-fu (JP); Takuji Nakagawa, Kyoto-fu (JP); Katsuhiko Tanaka, Osaka-fu (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: MURATA MANUFACTURING CO., LTD., Kyoto-fu (JP)

(21) Appl. No.: 10/509,730

(22) PCT Filed: May 27, 2003
(86) PCT No.: PCT/IB03/02031

§ 371 Date: Sep. 30, 2004

(30) Foreign Application Priority Data
May 28, 2002 (JP) 2002-154254

(51) Int. Cl. B32B 15/04

(52) U.S. Cl. 428/457

(57) ABSTRACT

There is provided a three dimensional periodic structure comprising two substances having different dielectric constants with a high contrast between the dielectric constants or refractive indexes, periodically distributed in a three dimensional space. A unit cell substrate having air holes in a diamond structure is formed by a stereo lithography method which repeats the step of irradiating light onto a liquid surface of a light-hardening resin such as a photosensitive epoxy resin in each layer in a cross-sectional pattern to be formed. Then, a conductive film made of, for example, Cu is formed by an electroless plating method on the surface of the unit cell substrate. Thus, a three dimensional periodic structure comprising two substances having different dielectric constants, i.e., resin and air, periodically distributed in a three dimensional space, and comprising a conductive film formed at an interface between the two substances is obtained.

### TECHNICAL FIELD

The present invention relates to a three dimensional periodic structure and a method of producing the same.

### BACKGROUND ART

A periodic potential distribution due to the nuclei in a solid crystal exhibits interference of an electron wave having a wavelength that corresponds to the lattice constant. For example, when the wavelength of the electron wave is very close to the potential period of the crystal, reflection occurs by three dimensional diffraction (Bragg diffraction). This phenomenon prevents the passage of electrons in a specific energy range. Thus, an electronic band gap, which is utilized in semiconductor devices, is formed.

Similarly, a three dimensional structure having a periodically changing refractive index or dielectric constant exhibits interference of electromagnetic waves, thus blocking the electromagnetic waves in a specific frequency range. In this case, the forbidden band is called a photonic band gap, and the three dimensional structure is called a photonic crystal.

It is considered that effect of such a photonic crystal can be utilized to provide a cut-off filter that prevents penetration of electromagnetic waves within a predetermined frequency band, or to provide a waveguide or a resonator by introducing to the periodic structure a nonuniform part that disturbs the frequency to trap light or electromagnetic waves. Applications such as an ultra-low threshold laser or an electromagnetic highly directional antenna are also considered.

In general, two types of standing waves are formed in a photonic crystal when the electromagnetic wave produces Bragg diffraction. FIGS. 1A and 1B show the two types of standing waves. Standing wave A (FIG. 1X) has high energy at a low dielectric constant area of the wave vibration, and standing wave B (FIG. 1B) has high energy at a high dielectric constant area of the wave vibration. Waves having an energy between the standing waves that split into two different modes cannot exist in the crystal, thereby producing the band gap. In order to broaden the band gap, the energy difference between the two standing waves is increased. This can be achieved by strengthening the contrast between the dielectric constants of two media to a high degree or by increasing the volume ratio of the media having the high dielectric constant.

The photonic crystal has a one-, two-, or three-dimensional structure. A three dimensional structure is needed for a complete photonic band gap.

In order to provide a three dimensional structure, there are, for example, a method of layering square material (PCT Japanese Patent Publication No. 2001-518707, Japanese Unexamined Patent Application Publication No. 2001-74955), a method of using a shape-preserving multilayer film by self cloning (Japanese Unexamined Patent Application Publication No. 2001-74954), a method of using stereo lithography (Japanese Unexamined Patent Application Publication No. 2000-341031, PCT Japanese Patent Publication No. 2001-502256), a method of distributing particles (Japanese Unexamined Patent Application Publication No. 2001-42144) and the like. These publications disclose technologies for producing photonic crystals by processing insulating, dielectric and semiconductor materials, such as organic materials, ceramics and Si, respectively.

However, these practical materials have a maximum relative dielectric constant of 15 in, for example, a band of 10 to 30 GHz and a maximum refractive index of 3.0. It is difficult to further increase the contrast of the dielectric constants and the refractive indexes.

### DISCLOSURE OF INVENTION

An object of the present invention is to provide a three dimensional periodic structure comprising two substances having different dielectric constants, with a high contrast between the dielectric constants or refractive indexes, periodically distributed in a three dimensional space, and a method of producing the same.

The present invention provides a three dimensional periodic structure comprising two substances having different dielectric constants periodically distributed in a three dimensional space, and a conductive film having a surface resistivity of about 0.3 Ω/square or more formed at an interface between the two substances.

Providing that a conductive film having a surface resistivity of about 0.3 Ω/square or more is formed, the two substances having different dielectric constants are periodically distributed in a three dimensional space, and current is prevented from flowing in the direction in which a metal film extends. Thus, an advantage equivalent to the case where the metal is coated with an insulation film is obtained.

In the present invention, there is formed a conductive film where independent conductive particles or clusters of a plurality of conductive particles are coarsely distributed at an interface between the two substances. With this structure, the two substances having different dielectric constants are periodically distributed in a three dimensional space, and current is prevented from flowing in the direction in which the metal film is extends. Thus, an advantage equivalent to the case where the metal is coated with an insulation film is obtained.

The conductive film comprises a conductive material having a conductivity of about 10³ S/cm or more.

The conductive film can be formed by an electroless plating method on a surface of either of the two substances.

A method of producing a three dimensional periodic structure according to the present invention is a stereo lithography method which repeats the step of irradiating light onto a light-hardening resin in each layer in a cross-sectional pattern to be formed to form either of the two substances of the three dimensional periodic structure.

### BRIEF DESCRIPTION OF THE DRAWINGS

FIGS. 1A and 1B are a diagram showing two standing waves when substances having different dielectric constants are periodically distributed.

FIGS. 2A and 2B are perspective views each showing the structure of a unit cell according to one embodiment.

FIG. 3 is a view showing one unit having air holes in a diamond structure in the unit cell.

FIG. 4A is a diagram showing the structure of a stereo lithography apparatus.

FIG. 4B is a sectional view showing a light-hardening resin 18 to which the laser beam is irradiated.

FIGS. 5A to 5C are diagrams each showing an object being formed by the stereo lithography apparatus.

FIG. 6 is a table showing the relationship between electroless plating time for plating a unit cell substrate and surface resistivity of a conductive film.

FIG. 7 is a diagram showing an electromagnetic wave property measuring device for the unit cell.

FIGS. 8A to 8H are graphs each showing the relationship between plating time for plating a conductive film on a unit cell substrate and penetration characteristics.

FIG. 9 is a graph showing the relationship among surface resistivity of a conductive film 2, center frequency of the band gap, and the apparent relative dielectric constant.

FIG. 10 is a photograph showing an AFM image of the surface of a conductive film on a unit cell formed by electroless plating.

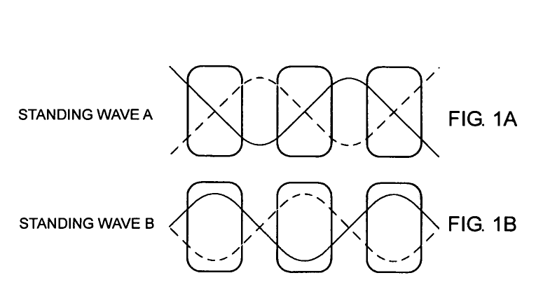

### BEST MODE FOR CARRYING OUT THE INVENTION

Referring to Figures, the three dimensional periodic structure and a method of producing the same will be described in turn.

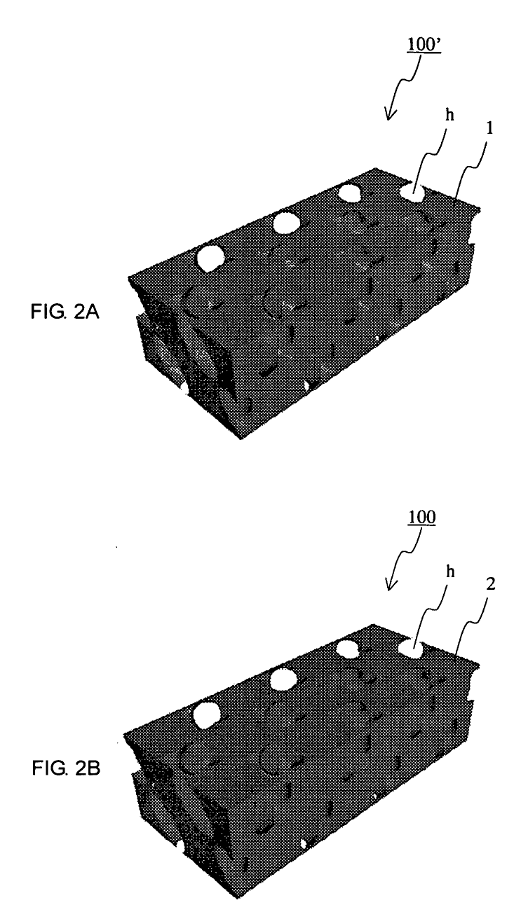

FIGS. 2A and 2B are perspective views each showing the three dimensional structure of a photonic crystal. FIG. 2A shows a hardened epoxy-based resin 1 and a plurality of holes h formed within a block of the resin 1. A unit cell substrate 100′ is constituted of the resin 1 including the holes h. FIG. 2B shows a state wherein a conductive film 2 is formed on a surface of the resin 1 shown in FIG. 2A. A unit cell 100 is constructed by forming the conductive film 2 at an interface between two substances having different dielectric constants, i.e., the resin 1 and air.

The holes h are periodically distributed within a three dimensional space, as described later. With this structure, there is provided a three dimensional periodic structure where the two substances having different dielectric constants, i.e., the resin 1 and air, are periodically distributed in a three dimensional space.

In order for the photonic crystal to develop a sufficient electromagnetic-wave reflection effect, it is necessary to form a wide band gap in all crystal directions. An ideal crystal structure is a three dimensional diamond structure. In the diamond structure, a unit lattice includes eight lattice points; four of them make an independent face centered cubic lattice, and one lattice is located at a position so that the lattice is moved ¼ of the length of the other lattice along a steric diagonal line.

The photonic crystal in the diamond structure is a crystal where spherical dielectrics are located at the lattice points of the diamond structure, or a crystal that simulates atomic bonds of the diamond structure by combining dielectric columns. FIG. 3 shows a perspective view of the latter unit structure. For simplicity, only the shape of the air hole is shown.

In the unit cell substrate 100′ shown in FIG. 2A, the air holes in the diamond-type lattice structure shown in FIG. 3 are periodically distributed in the resin 1. Such a structure can be referred to as a reverse diamond structure. The ratio of the diameter to the length in columns in the lattice is about 2:3 (aspect ratio about 1.5). The lattice constant is 10 mm.

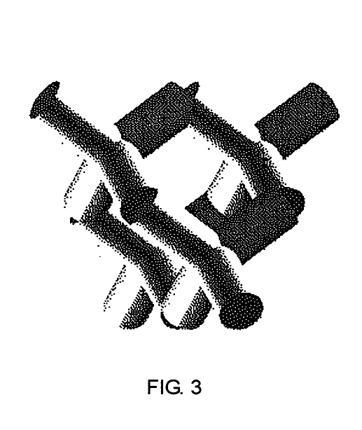

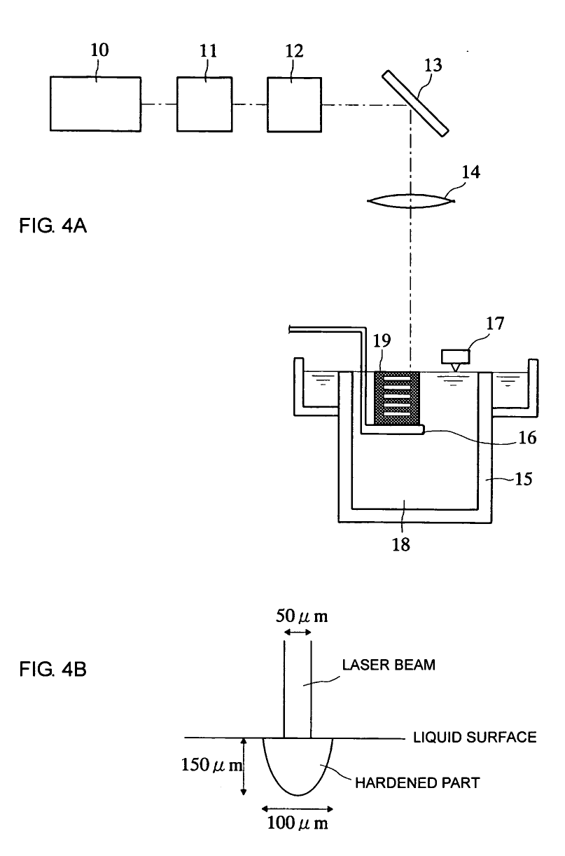

FIG. 4A shows an apparatus for producing the unit cell substrate 100′ shown in FIG. 2A. A container 15 for filling an epoxy-based light-hardening resin 18 that is hardened by ultraviolet rays, an elevator table 16 that moves upward and downward within the container 15, an object 19 formed on the top of the elevator table 16, and a squeegee 17 for coating the light-hardening resin 18 on an object 19 in the predetermined film thickness are shown.

Also, a laser diode 10, a harmonic generating element (LBO) 11 for changing the wavelength of the laser light from the laser diode 10 to produce ultraviolet rays, an acousto-optical element (AOM) 12 functioning as a wavelength selecting element, a scan mirror 13, and fθ lens 14 are shown. Thus, an optical system is configured.

A process sequence of producing the photonic crystal using the stereo lithography apparatus is described below.

Firstly, the elevator table 16 is lowered from the liquid surface of the light-hardening resin 18 to a predetermined depth. The squeegee 17 is moved along the liquid surface to form a light-hardening resin film having a thickness of about 100 μm on the surface of the elevator table 16. The liquid surface is then irradiated with ultraviolet rays having a wavelength of 355 nm with a spot diameter of 50 μm and an output power of 110 mW by the optical system. The scan mirror 13 is controlled to modulate the laser diode 10 so that the laser light is irradiated to an area where the light-hardening resin 18 is to be hardened, but is not irradiated to other areas. See, e.g., FIG. 4B.

A spherical hardened phase having a diameter of 120 μm is formed by a polymerization reaction on the liquid surface of the light-hardening resin 18 to which the laser beam is irradiated. When the laser beam is scanned at a speed of 90 m/s, a hardened phase having a thickness of 150 μm is formed. The object 19 corresponding to a first layer cross-sectional pattern is formed by raster scanning the laser beam.

Then, the elevator table 16 is lowered by about 200 μm. The squeegee 17 is moved to form a light-hardening resin film having a thickness of about 200 μm on the surface of the object 19.

Thereafter, a second layer cross-sectional pattern is formed on the first layer by scanning and modulating the laser beam similarly to the first layer. The first and second layers are adhered by polymerization hardening. Third and subsequent layers are formed in the same manner. By repeating the processing, the object 19 is constructed.

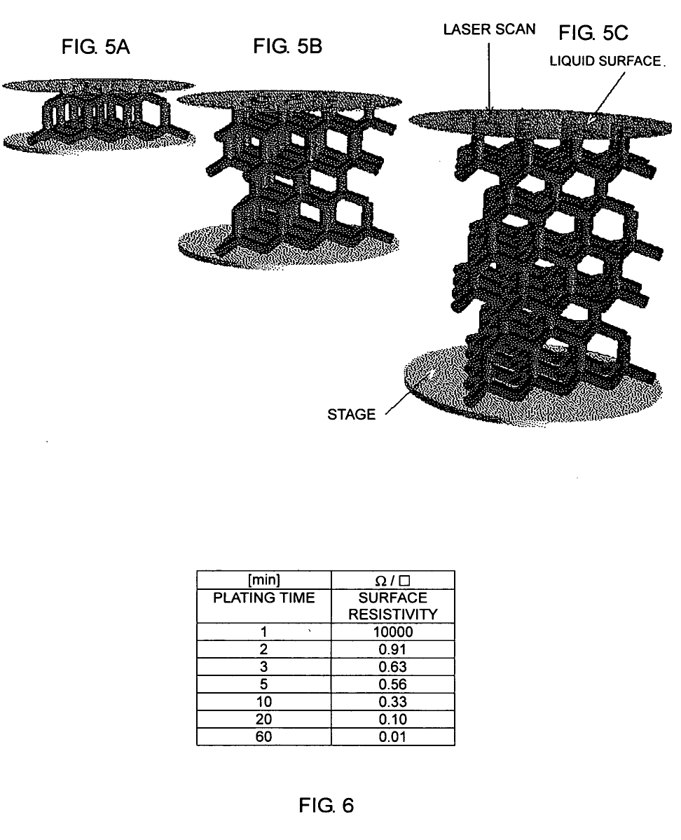

FIGS. 5A to 5C are perspective diagrams each showing an object in each of the steps for forming a number of layers. For simplicity, parts that are not hardened without laser beam irradiation, i.e., the hole patterns are shown. FIG. 5A shows substantially only one unit in the <111> crystal axis direction of the diamond structure shown in FIG. 3. FIG. 5B shows substantially four units. FIG. 5C shows a numbers of units.

A CAD/CAM process is used to harden the light-hardening resin 18 in the predetermined cross-sectional patterns at the liquid surface of the light-hardening resin 18. Specifically, the pattern shown in FIGS. 5A to 5C are designed in advance by a CAD system capable of handling three dimensional data. The three dimensional data is converted into STL (stereolithography) data. The STL data is converted into a set of two dimensional data at predetermined positions using slicing software. Finally, with the two dimensional data, data for modulating the laser diode, when the laser beam is raster scanned, is created. Based on the thus-prepared data, the laser beam is scanned and the laser diode is modulated.

The target 19 made of the light-hardening resin formed by the aforementioned procedures is removed from the container 15. The unhardened light-hardening resin is washed, dried and cut to the predetermined size. Thus, the unit cell substrate 100′ shown in FIG. 2A is constructed. The holes h of the unit cell substrate 100′ are periodically distributed in three dimensional space. Accordingly, diamond-structure cells may be formed repeatedly in all axial directions of the crystal using the apparatus shown in FIG. 4A. The cells may be cut to the predetermined size in the predetermined direction to provide the unit cell substrate 100′.

As shown in FIG. 2B, the conductive film 2 is formed on the thus-formed unit cell substrate 100′. A method of forming the conductive film and changes in the properties due to the formation of the conductive film will be described below.

The conductive film 2 is formed by coating Cu, Ni or the like on the unit cell substrate 100′ using an electroless plating method. FIG. 6 is a table showing the relationship between plating time for carrying out Cu electroless plating on the unit cell substrate 100′ and the surface resistivity of the conductive film (Cu film).

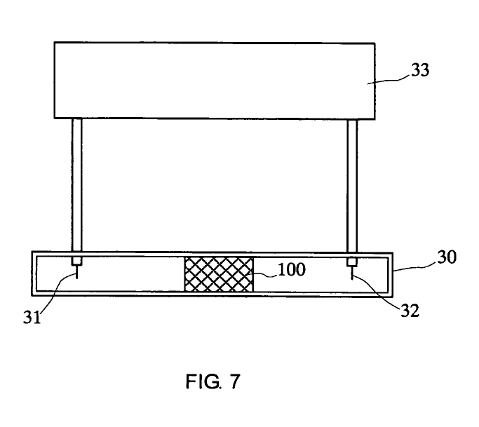

FIG. 7 shows a measuring device for measuring properties of the unit cell 100. An M-band waveguide 30 and probes 31 and 32 inserted into the waveguide 30 are shown. The unit cell 100 is inserted into the waveguide 30 as a sample. A network analyzer 33 is connected to the probes 31 and 32. Using the network analyzer 33, the penetration characteristics of the electromagnetic wave are measured. In FIG. 7, the unit cell 100 is disposed so that the <100> crystal axis of the diamond structure having the holes h directs to the electromagnetic wave transmission direction of the waveguide 30. The waveguide 30 has an internal size of 20 mm (horizontal)×10 mm (vertical). The unit cell 100 has a size of 20 mm in the longitudinal direction of the waveguide 30, and 10 mm in the height direction of the waveguide 30.

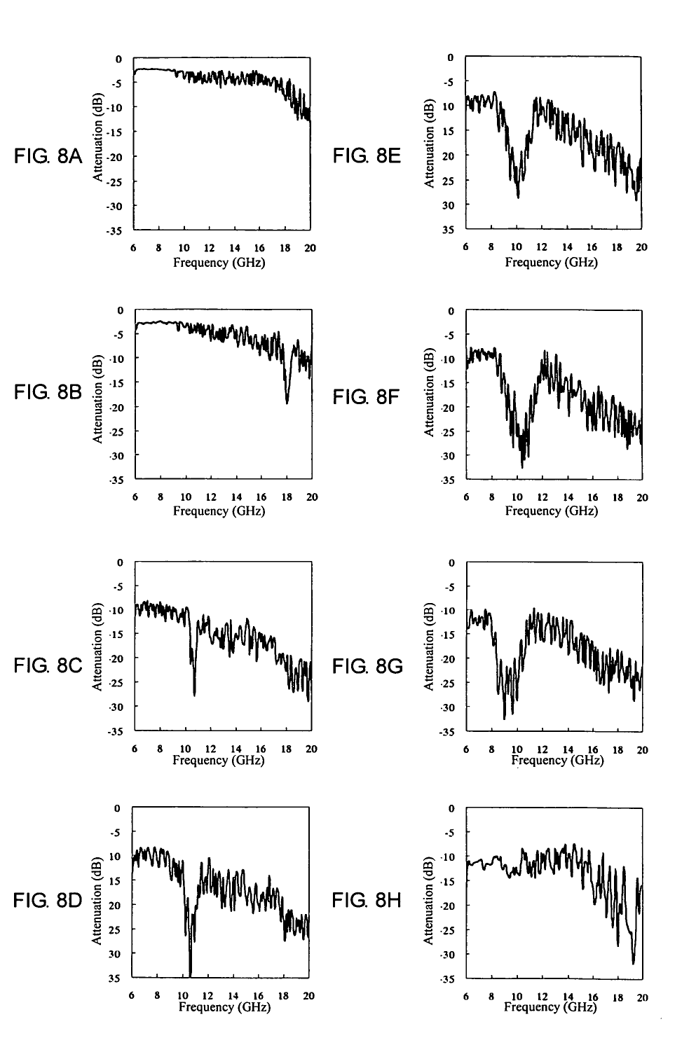

FIGS. 8A to 8H are graphs each showing a penetration characteristics when the plating time of Cu electroless plating and the state of the Cu film are changed. Each abscissa represents frequency (GHz), and each ordinate represents attenuation (dB), which is the logarithm of the intensity ratio of the input of the electromagnetic wave to the output thereof. The state indicating that the signal intensities of the input and the output are equal is 0(dB).

FIG. 8A represents the characteristics in the state where the unit cell 100 is not inserted into the waveguide 30. FIG. 8B represents the characteristics in the state where the unit cell substrate 100′, on which the Cu film is not yet formed, is inserted into the waveguide 30. FIGS. 8C to 8H represent the characteristics when the plating time of the Cu electroless plating is changed from 1 to 20 minutes.

Corresponding to FIGS. 7A to 7H, the following table shows the relationships among the plating time, the surface resistivity, the Cu film thickness, and the band gap obtained.

TABLE 1

| | | Ω/ | | GHz | | | dB |
|---|---|---|---|---|---|---|---|
| | min | square | Mm | gap | GHz | | attenuation |
| | Plating | surface | film | center | Band- | dB | at lowest |
| FIG. | time | resistivity | thickness | frequency | width | attenuation | point |
| 7B | 0 | 100000 | | 18.0 | 0.9 | 12.0 | 19.5 |
| 7C | 1 | 10000 | | 10.7 | 0.9 | 15.6 | 28.2 |
| 7D | 2 | 0.91 | 0.08 | 10.6 | 1.5 | 24.9 | 35.0 |
| 7E | 3 | 0.63 | 0.12 | 10.4 | 3.9 | 20.5 | 29.1 |
| 7F | 5 | 0.56 | 0.18 | 10.4 | 3.9 | 24.6 | 33.3 |
| 7G | 10 | 0.33 | 0.36 | 9.0 | 3.5 | 23.0 | 33.5 |
| 7H | 20 | 0.10 | 0.75 | | | | |

“Gap center frequency” herein means the frequency at the lowest point (maximum attenuation point).
“Band gap width” herein means the bandwidth when the attenuation has the value shown in the “attenuation” column.
“Attenuation at lowest point” herein means the point with the lowest attenuation.

As shown in FIG. 8B, the attenuation in the case of the unit cell substrate 100′ having no conductive film is −19.5 (dB) at 18.0 GHz with the band gap. The bandwidth is 0.9 GHz in view of the attenuation −12.0 (dB). As shown in FIG. 8C, the attenuation in the case of the unit cell substrate 100′ on which Cu electroless plating is conducted for one minute is about −28.2 (dB) at 10.7 GHz. The bandwidth is 0.9 GHz in view of the attenuation −15.6 (dB). When the eletroless plating time is lengthened to two, three, five and ten minutes, both the attenuation and the bandwidth increase as shown in FIGS. 8D to 8G, respectively. In other words, the band gap increases.

Thus, a larger band gap is obtained by forming the conductive film 2 as compared with that of the unit cell substrate 100′. It is recognized that the more the density of the conductive film 2 increases, the larger is the band gap. By forming the conductive film 2 on the unit cell substrate 100′, the frequency at which the band gap appears is decreased. In other words, the apparent dielectric constant of the unit cell becomes high. This is equivalent to providing a photonic crystal with a high dielectric constant material.

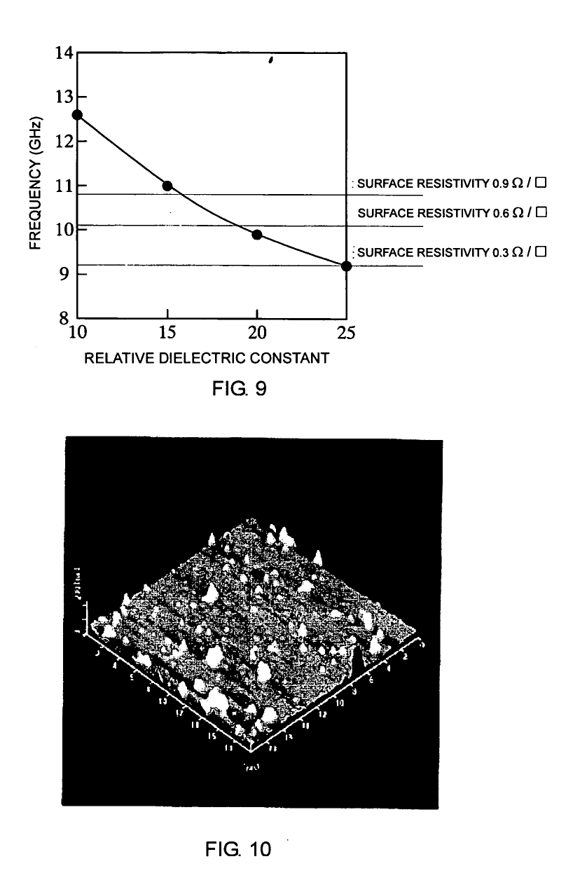

FIG. 9 is a graph showing the relationship among surface resistivity of the dielectric film 2, center frequency of the band gap, and the apparent relative dielectric constant.

The longer is the plating time and the lower is the surface resistivity of the conductive film 2, the higher is the apparent relative dielectric constant. The unit cell can be small for obtaining attenuation in the same frequency band.

However, as shown in FIG. 8H, when the plating time of the Cu electroless plating is 20 minutes or more, the band gap disappears. It is thought that this is because the density of the conductive film 2 becomes too high, reaching a state equivalent to the metal having the structure shown in FIG. 2 being inserted into the waveguide.

FIG. 10 is a photograph showing an AFM image (image observed by an atomic force microscope) of the conductive film 2 when the plating time of the Cu electroless plating is two minutes. Individual plural protrusions in the image represent Cu particles. Each of them exists independently. Alternatively, plural Cu particles may exist in a cluster state. Whole clusters are not connected to each other, and are distributed coarsely. In other words, the conductive particles are in a state of a discontinuous metal film. This prevents the current from being conducted along a relatively long path in the direction in which the Cu film extends. Thus, an advantage equivalent to the case where the metal is coated with an insulation film is obtained.

When the plating time is 20 minutes or more, the Cu particles exist sequentially, and a Cu film through which the current is freely conducted in the direction in which the metal film extends is formed. Therefore, the structure comprising the two substances having different dielectric constants periodically distributed in three dimensional space has no effect, whereby the band gap may disappear.

As shown in FIG. 6, a plating time of 10 minutes corresponds to a surface resistivity of about 0.3 Ω/square. The conductive film having a surface resistivity of about 0.3 Ω/square or more may be formed at an interface of the two substances of the three dimensional periodic structure. As to the state of the conductive film, a conductive film wherein independent conductive particles or clusters of the plural conductive particles are coarsely distributed may be formed at the interface between the two substances.

When Ni or InSb was used as the conductive material of the conductive film 2 instead of Cu, the same results were obtained. Cu has a conductivity of 5.8) 10⁵ S/cm, Ni has a conductivity of 1.5×10⁵ S/cm and in Sb has a conductivity of 1.0×10³ S/cm. It is considered that the same advantages can be achieved when a conductive material including other metals is electroless plated, as long as the conductive material has a conductivity of about 10³ S/cm or more.

The conductive film 2 can be formed on the unit cell substrate 100′ not only by the electroless plating method, but also by a sputtering method, a CVD method, a vacuum vapor deposition method, and a coating method for coating, drying, and solidifying a resin in which metal powder is dispersed as the conductive particles.

According to the present invention, the three dimensional periodic structure comprises two substances having different dielectric constants periodically distributed in a three dimensional space, and a conductive film having a surface resistivity of about 0.3 Ω/square or more is formed at an interface between the two substances. Alternatively, the three dimensional periodic structure comprises the conductive film formed at the interface between the two substances, in which independent conductive particles or clusters of a plurality of conductive particles are coarsely distributed in the film. Thus, the two substances having different dielectric constants are periodically distributed in three dimensional space, and a current is prevented from being conducted in the direction in which the metal film extends. Thus, an advantage equivalent to the case where the metal is coated with an insulation film is obtained. In other words, there is provided a three dimensional periodic structure with a high contrast between dielectric constants or refractive indexes.

Also, according to the present invention, the conductive film comprises a conductive material having a conductivity of about 10³ S/cm or more, whereby a large band gap can be obtained. In addition, the apparent dielectric dielectric constant is increased, resulting in a small structure.

The conductive film is formed by electroless plating on a surface of either of the two substances. Therefore, a conductive film where independent conductive particles or clusters of a plurality of conductive particles are coarsely distributed at the interface between the two substances can be produced, which enhances the productivity.

According to the present invention, a stereo lithography method which repeats the step of irradiating light onto a light-hardening resin in each layer in a cross-sectional pattern is used, whereby a three dimensional periodic structure where either of the two substances is distributed can be easily produced, and where the conductive film is formed at the interface of the two substances.

1. A three dimensional periodic structure, comprising:
two substances having different dielectric constants periodically distributed in a three dimensional space, and
a conductive film having a surface resistivity of about 0.3 Ω/square or more at an interface between the two substances.

2. A three dimensional periodic structure according to claim 1, wherein independent conductive particles or clusters of a plurality of conductive particles are coarsely distributed in the conductive film.

3. A three dimensional periodic structure according to claim 2, wherein the conductive film comprises a conductive material having a conductivity of about 10³ S/cm or more.

4. A three dimensional periodic structure according to claim 3, wherein the conductive film is an electroless plating film on a surface of at least one of the two substances.

5. A three dimensional periodic structure according to claim 2, wherein the conductive film is an electroless plating film on a surface of at least one of the two substances.

6. A three dimensional periodic structure according to claim 2, wherein the conductive film comprises Cu, Ni or InSb.

7. A three dimensional periodic structure according to claim 2, wherein one of the two substances is air and is disposed so as to have a diamond shape.

8. A method of producing a three dimensional periodic structure comprising irradiating light onto a light-hardening resin layer in cross-sectional pattern to form a layer of three dimensional periodic structure according to claim 1, and then, at least once, causing a layer of light-hardening resin to contact the resulting irradiated structure and repeating the irradiation.

9. A three dimensional periodic structure according to claim 1, wherein the conductive film comprises a conductive material having a conductivity of about 10³ S/cm or more.

10. A three dimensional periodic structure according to claim 9, wherein the conductive film is an electroless plating film on a surface of at least one of the two substances.

11. A three dimensional periodic structure according to claim 1, wherein the conductive film is an electroless plating film on a surface of at least one of the two substances.

12. A three dimensional periodic structure according to claim 1, wherein the conductive film comprises Cu, Ni or InSb.

13. A three dimensional periodic structure according to claim 1, wherein one of the two substances is air and is disposed so as to have a diamond shape.
